(19) United States
(12) Patent Application Publication
(10) Pub. No.: US 2016/0195725 A1
(43) Pub. Date: Jul. 7, 2016

(54) WEARABLE AUDIO-VISUAL DEVICE

(71) Applicant: Dashbon, Inc., New Taipei City (TW)

(72) Inventors: CHIEN-WEN HSU, New Taipei City (TW); PO-LIN WANG, New Taipei City (TW); CHING-TE CHU, New Taipei City (TW); CHEN-AN WU, New Taipei City (TW); HUNG-CHANG YEH, New Taipei City (TW)

(21) Appl. No.: 14/974,828

(22) Filed: Dec. 18, 2015

(30) Foreign Application Priority Data
Jan. 5, 2015 (TW) 104200036

(51) Int. Cl. G02B 27/01; G02B 7/04; H04R 1/02; G02B 13/16; G02B 27/28; H04R 1/10

(52) U.S. Cl. CPC G02B 27/0176; G02B 27/283; G02B 27/0172; H04R 1/10; H04R 1/028; G02B 13/16; H04R 1/1041; G02B 7/04; G02B 2027/0156; G02B 2027/0158; H04R 2430/01

(57) ABSTRACT

A wearable audio-visual device includes a casing structure, a first image generating unit, a second image generating unit, and two earphone structures. The casing structure includes a main casing and two lateral casings. The first image generating unit includes a first exposed portion exposed from the main casing. The first exposed portion has a first viewing area, and a first eye image light source generated by the first image generating unit passes through the first viewing area and then is projected onto a first eye. The second image generating unit includes a second exposed portion exposed from the main casing. The second exposed portion has a second viewing area, and a second eye image light source generated by the second image generating unit passes through the second viewing area and then is projected onto a second eye. The two earphone structures respectively disposed on the two lateral casings.

### BACKGROUND OF THE INVENTION

1. Field of the Invention

The instant disclosure relates to a wearable audio-visual device, and more particularly to a wearable audio-visual device for providing image and sound information.

2. Description of Related Art

In the modern information society, various types of data, information, news, knowledge, opinions and ideas displayed in the form of audios or/and images are carried in electronic media/multi-media data, which are played/reconstructed by a playback system via an audio-visual approach. The playback system comprises a source device and a playback device. The source device provides a multi-media data as a source signal to the playback device, and the playback device comprising a speaker and a display panel converts the source signal to audios and images.

Since modern information becomes popularized and develops prosperously, types of the source devices get diversified day by day. For example, the source device is a digital video disk (DVD) player and recorder, a blue-ray player and recorder, a modulating/demodulating modem and set-up box for receiving multi-media data via wired and/or wireless network, a multi-media player for reading multi-media data from a hard disk/flash memory/flash card, a game console, even a digital camera, a camcorder, a mobile phone and handhold device having an audio-visual output function. The playback device is an audio system, a monitor, a television (TV), a projector, and the like.

### SUMMARY OF THE INVENTION

One aspect of the instant disclosure relates to a wearable audio-visual device for providing image and sound information.

One of the embodiments of the instant disclosure provides a wearable audio-visual device worn on the head of a user, comprising: a casing structure, a first image generating unit, a second image generating unit, and two earphone structures. The casing structure includes a main casing and two lateral casings respectively connected to two opposite sides of the main casing. The main casing has a top side, a bottom side, and an inner side surface, each lateral casing has an inner side surface, and the two inner side surfaces of the two lateral casings correspond to each other. The first image generating unit includes a first polarization beam splitter module, a first light emitting module adjacent to the first polarization beam splitter module, a first image display module adjacent to the first polarization beam splitter module, and a first lens module adjacent to the first polarization beam splitter module. One portion of the first lens module is exposed from the inner side surface of the main casing and corresponds to a first eye of the user, and the first polarization beam splitter module, the first light emitting module, the first image display module, and the other portion of the first lens module are enclosed inside the main casing. The second image generating unit includes a second polarization beam splitter module, a second light emitting module adjacent to the second polarization beam splitter module, a second image display module adjacent to the second polarization beam splitter module, and a second lens module adjacent to the second polarization beam splitter module. One portion of the second lens module is exposed from the inner side surface of the main casing and corresponds to a second eye of the user, and the second polarization beam splitter module, the second light emitting module, the second image display module, and the other portion of the second lens module are enclosed inside the main casing. The two earphone structures are respectively disposed on the two inner side surfaces of the two lateral casings.

More particularly, a first light source generated by the first light emitting module passes through the first polarization beam splitter module and then is projected onto the first image display module, the first light source is reflected by the first image display module to form a first image light source, and the first image light source is reflected by the first polarization beam splitter module and then passes through the first lens module to form a first eye image light source that is projected onto the first eye of the user. A second light source generated by the second light emitting module passes through the second polarization beam splitter module and then is projected onto the second image display module, the second light source is reflected by the second image display module to form a second image light source, and the second image light source is reflected by the second polarization beam splitter module and then passes through the second lens module to form a second eye image light source that is projected onto the second eye of the user.

Another one of the embodiments of the instant disclosure provides a wearable audio-visual device worn on the head of a user, comprising: a casing structure, a first image generating unit, a second image generating unit, and two earphone structures. The casing structure includes a main casing and two lateral casings respectively connected to two opposite sides of the main casing. The first image generating unit includes a first exposed portion exposed from the main casing and a first hidden portion enclosed inside the main casing. The first exposed portion has a first viewing area corresponding to a first eye of the user, and a first eye image light source generated by the first image generating unit passes through the first viewing area and then is projected onto the first eye of the user. The second image generating unit includes a second exposed portion exposed from the main casing and a second hidden portion enclosed inside the main casing. The second exposed portion has a second viewing area corresponding to a second eye of the user, and a second eye image light source generated by the second image generating unit passes through the second viewing area and then is projected onto the second eye of the user. The two earphone structures respectively disposed on the two lateral casings.

To further understand the techniques, means and effects of the instant disclosure applied for achieving the prescribed objectives, the following detailed descriptions and appended drawings are hereby referred to, such that, and through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

The accompanying drawings are included to provide a further understanding of the instant disclosure, and are incorporated in and constitute a part of this specification. The drawings illustrate exemplary embodiments of the instant disclosure and, together with the description, serve to explain the principles of the instant disclosure.

FIG. 1 shows a perspective, schematic view of the wearable audio-visual device according to the instant disclosure;

FIG. 2 shows another perspective, schematic view of the wearable audio-visual device according to the instant disclosure;

FIG. 3 shows a perspective, schematic view of the wearable audio-visual device after rotating the movable cover plate to expose the first viewing area and the second viewing area according to the instant disclosure;

FIG. 4 shows a lateral, schematic view of the wearable audio-visual device worn on the head of a user according to the instant disclosure;

FIG. 5 shows a lateral, cross-sectional, schematic view of a first image generating unit and a second image generating unit of the wearable audio-visual device according to the instant disclosure;

FIG. 6 shows another lateral, schematic view of the wearable audio-visual device worn on the head of a user according to the instant disclosure; and

FIG. 7 shows a lateral, cross-sectional, schematic view of another first image generating unit and another second image generating unit of the wearable audio-visual device according to the instant disclosure.

### DETAILED DESCRIPTION OF THE PREFERRED EMBODIMENTS

The embodiments of a wearable audio-visual device of the instant disclosure are described. Other advantages and objectives of the instant disclosure can be easily understood by one skilled in the art from the disclosure. The instant disclosure can be applied in different embodiments. Various modifications and variations can be made to various details in the description for different applications without departing from the scope of the instant disclosure. The drawings of the instant disclosure are provided only for simple illustrations, but are not drawn to scale and do not reflect the actual relative dimensions. The following embodiments are provided to describe in detail the concept of the instant disclosure, and are not intended to limit the scope thereof in any way.

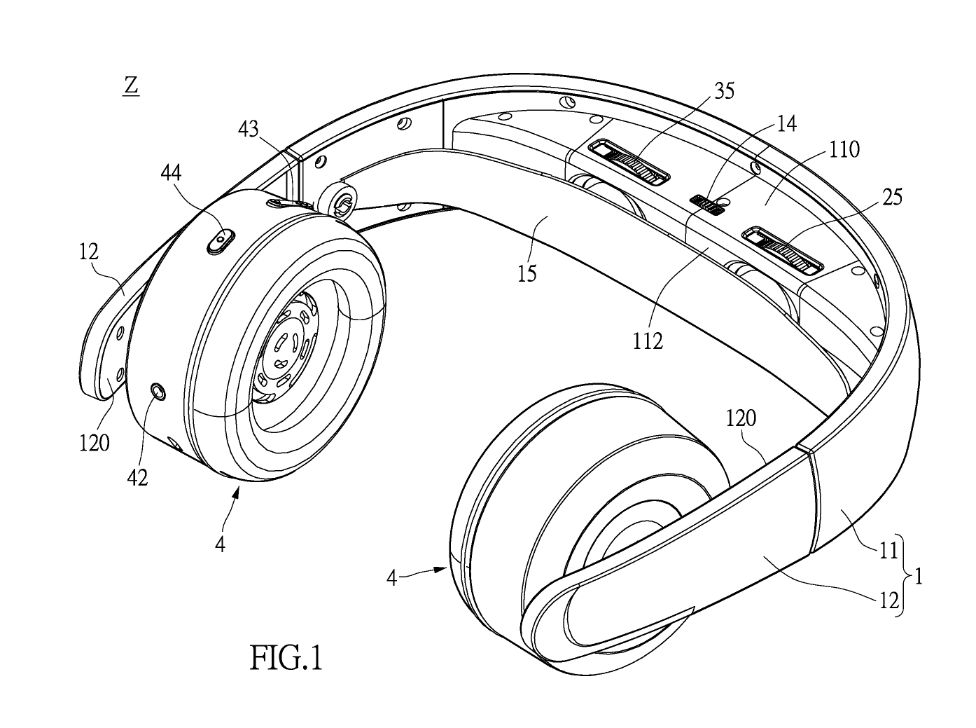

Referring to FIG. 1 to FIG. 7, the instant disclosure provides a wearable audio-visual device Z worn on the head H of a user. The wearable audio-visual device Z comprises a casing structure 1, a first image generating unit 2, a second image generating unit 3, and two earphone structures 4.

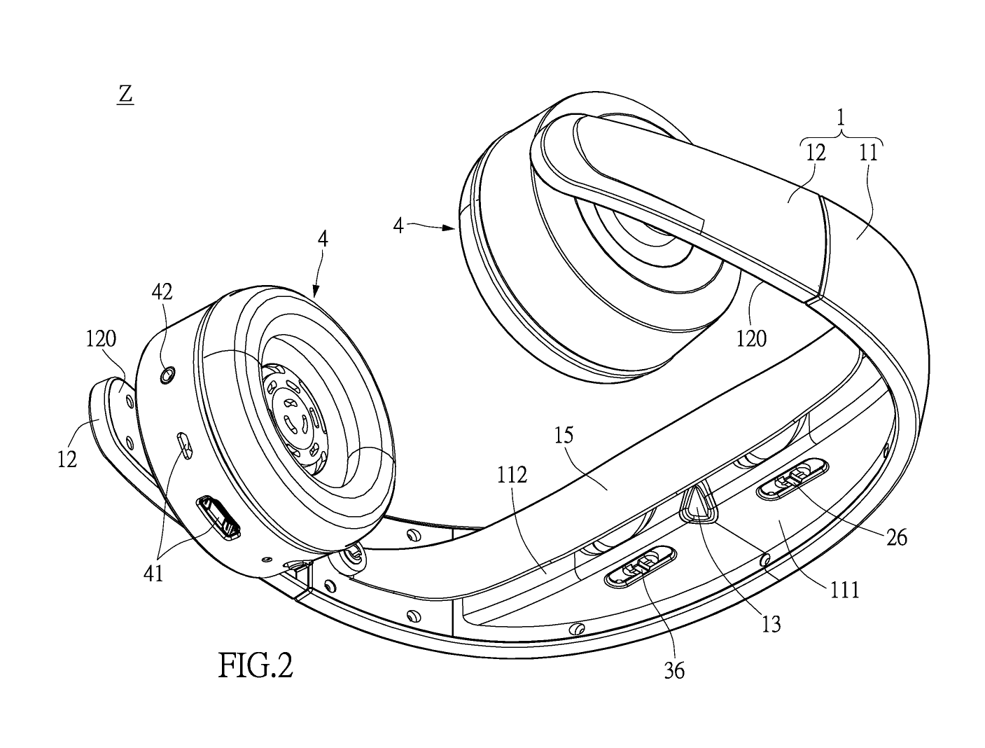

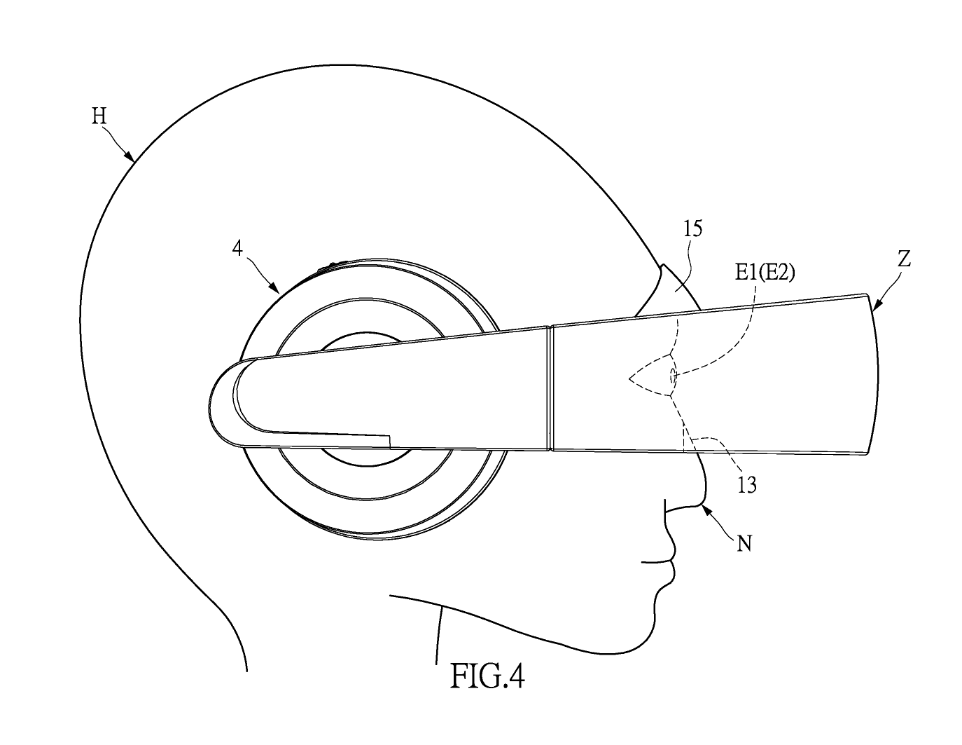

First, referring to FIG. 1, FIG. 2, and FIG. 4, the casing structure 1 includes a main casing 11 and two lateral casings 12 respectively connected to two opposite sides of the main casing 11, and the main casing 11 and the two lateral casings 12 are mated with each other to form an eyeglasses. In addition, the main casing 11 has a top side 110, a bottom side 111, and an inner side surface 112, each lateral casing 12 has an inner side surface 120, and the two inner side surfaces 120 of the two lateral casings 12 correspond to each other or opposite to each other. More particularly, the casing structure 1 includes a movable nose pad 13 movably disposed on the inner side surface 112 of the main casing 11 and a height adjusting element 14 disposed on the top side 110 of the main casing 11, and the movable nose pad 13 is moved to abut against the nose N of the user by adjusting the height adjusting element 14 (as shown in FIG. 4).

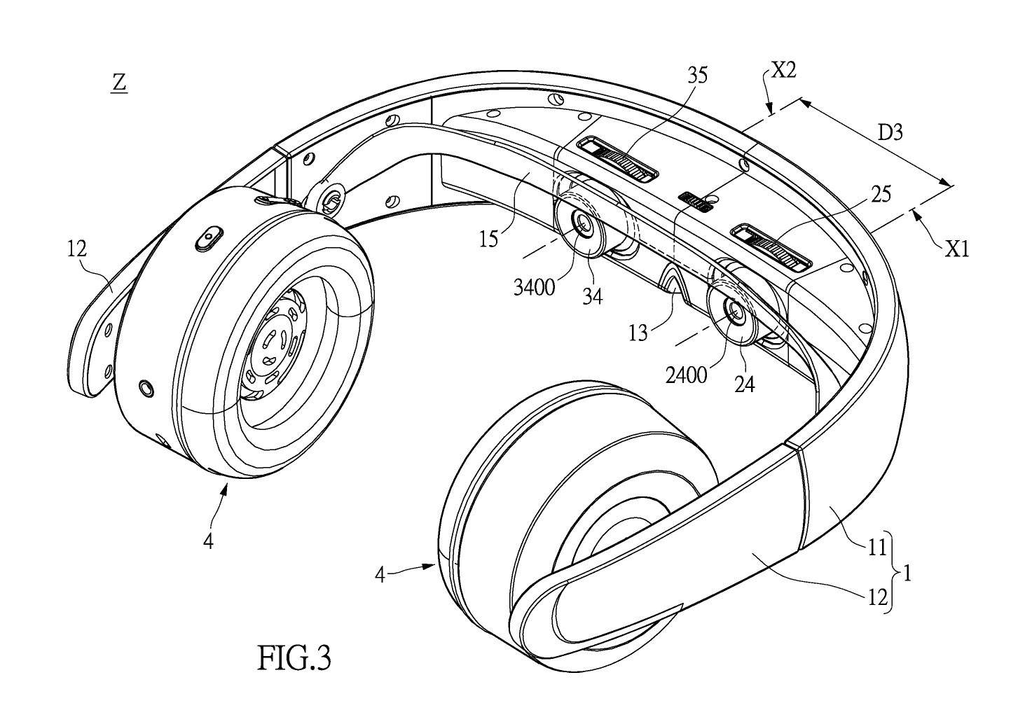

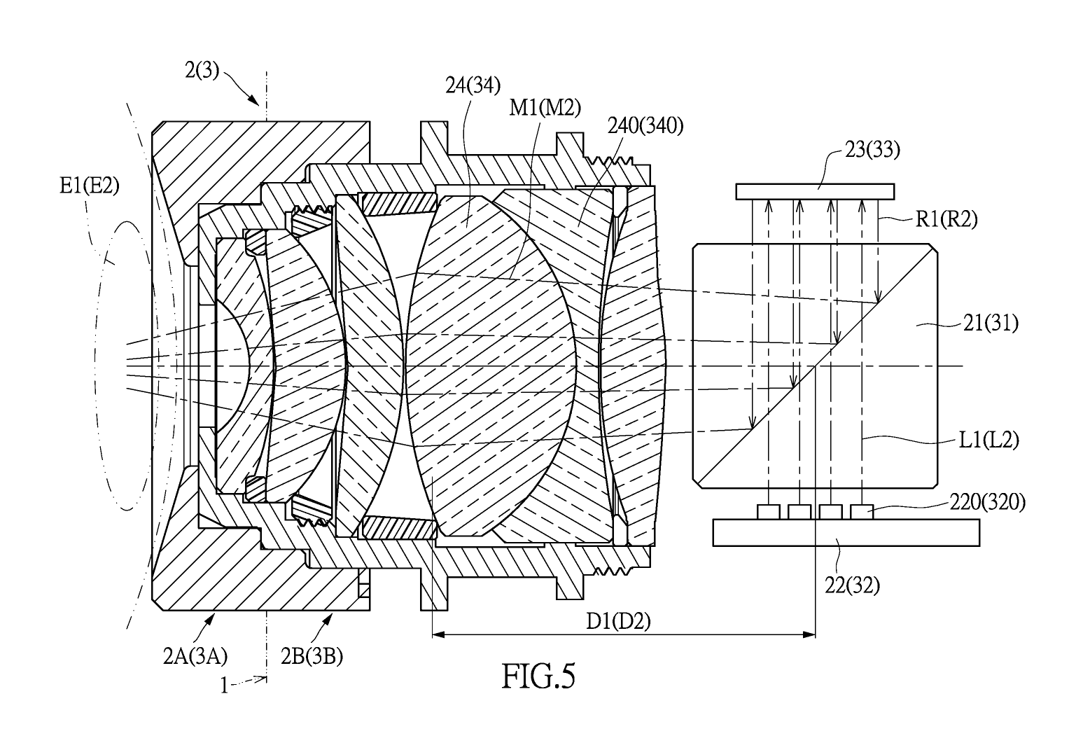

Moreover, referring to FIG. 3, FIG. 4, and FIG. 5, the first image generating unit 2 includes a first polarization beam splitter module 21, a first light emitting module 22 (may be composed of many first LEDs 220) adjacent to the first polarization beam splitter module 21, a first image display module 23 (such as a liquid crystal on silicon (LCOS) panel) adjacent to the first polarization beam splitter module 21, and a first lens module 24 (may be composed of many first lenses 240) adjacent to the first polarization beam splitter module 21. In addition, one portion of the first lens module 24 is exposed from the inner side surface 112 of the main casing 11 and corresponds to a first eye E1 of the user, and the first polarization beam splitter module 21, the first light emitting module 22, the first image display module 23, and the other portion of the first lens module 24 are enclosed inside the main casing 11. More particularly, as shown in FIG. 5, a first light source L1 generated by the first light emitting module 22 passes through the first polarization beam splitter module 21 and then is projected onto the first image display module 23, the first light source L1 is reflected by the first image display module 23 to form a first image light source R1, and the first image light source R1 is reflected by the first polarization beam splitter module 21 and then passes through the first lens module 24 to form a first eye image light source M1 that is projected onto the first eye E1 of the user. In conclusion, the first image generating unit 2 includes a first exposed portion 2A exposed from the main casing 11 and a first hidden portion 2B enclosed inside the main casing 11. In addition, the first exposed portion 2A has a first viewing area 2400 corresponding to a first eye E1 of the user, and a first eye image light source M1 generated by the first image generating unit 2 passes through the first viewing area 2400 and then is projected onto the first eye E1 of the user.

Furthermore, referring to FIG. 3, FIG. 4, and FIG. 5, the second image generating unit 3 includes a second polarization beam splitter module 31, a second light emitting module 32 (may be composed of many second LEDs 320) adjacent to the second polarization beam splitter module 31, a second image display module 33 (such as a liquid crystal on silicon (LCOS) panel) adjacent to the second polarization beam splitter module 31, and a second lens module 34 (may be composed of many second lenses 340) adjacent to the second polarization beam splitter module 31. In addition, one portion of the second lens module 34 is exposed from the inner side surface 112 of the main casing 11 and corresponds to a second eye E2 of the user, and the second polarization beam splitter module 31, the second light emitting module 32, the second image display module 33, and the other portion of the second lens module 34 are enclosed inside the main casing 11. More particularly, as shown in FIG. 5, a second light source L2 generated by the second light emitting module 32 passes through the second polarization beam splitter module 31 and then is projected onto the second image display module 33, the second light source L2 is reflected by the second image display module 33 to form a second image light source R2, and the second image light source R2 is reflected by the second polarization beam splitter module 31 and then passes through the second lens module 34 to form a second eye image light source M2 that is projected onto the second eye E2 of the user. In conclusion, the second image generating unit 3 includes a second exposed portion 3A exposed from the main casing 11 and a second hidden portion 3B enclosed inside the main casing 11. In addition, the second exposed portion 3A has a second viewing area 3400 corresponding to a second eye E2 of the user, and a second eye image light source M2 generated by the second image generating unit 3 passes through the second viewing area 3400 and then is projected onto the second eye E2 of the user.

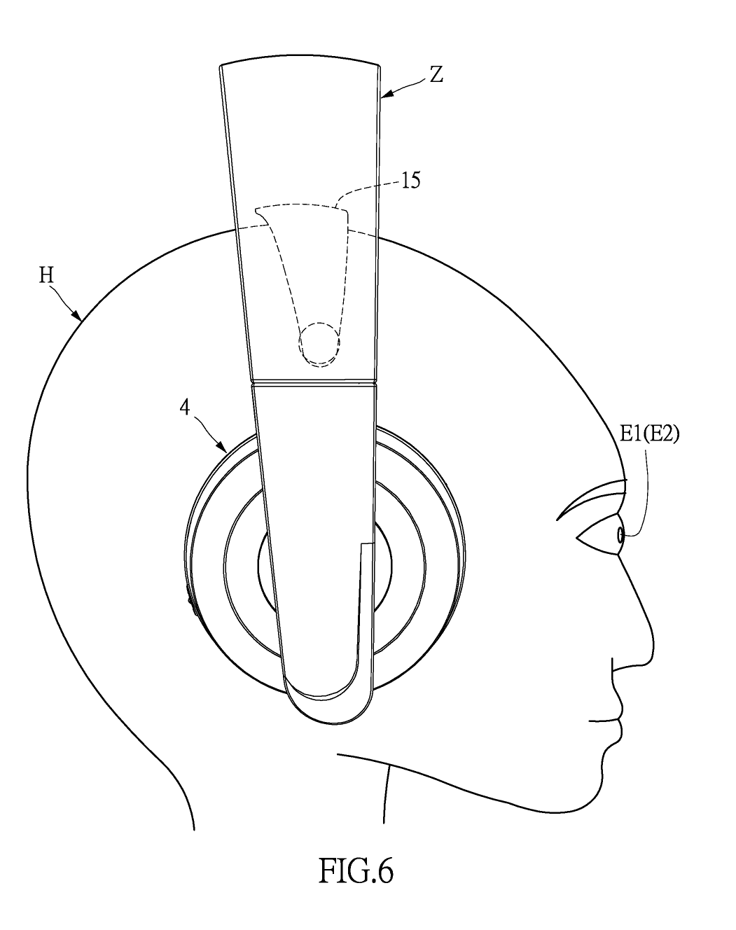

More particularly, referring to FIG. 1 and FIG. 3, the first lens module 24 has a first viewing area 2400 exposed from the inner side surface 112 of the main casing 11, and the second lens module 34 has a second viewing area 3400 exposed from the inner side surface 112 of the main casing 11. In addition, the casing structure 1 includes a movable cover plate 15 movably disposed on the inner side surface 112 of the main casing 11, and two opposite end portions of the movable cover plate 15 are respectively pivotally disposed on two opposite positions of the inner side surface 112 of the main casing 11 so as to concurrently cover (as shown in FIG. 1) or expose (as shown in FIG. 3) the first viewing area 2400 of the first lens module 24 and the second viewing area 3400 of the second lens module 34. For example, when the wearable audio-visual device Z is rotated by 90 degrees as shown in FIG. 6, not only the wearable audio-visual device Z can be supported on the head H of the user by the movable cover plate 15, but also the first viewing area 2400 of the first lens module 24 and the second viewing area 3400 of the second lens module 34 can be covered by the movable cover plate 15, in order to prevent the first viewing area 2400 and the second viewing area 3400 from being touched by the hair (greasy dirt) of the user.

More particularly, referring to FIG. 3, FIG. 4, and FIG. 5, the first image generating unit 2 includes a first focus adjusting element 25 disposed on the top side 110 of the main casing 11, and a first distance D1 between the centric position of the first lens module 24 and the centric position of the first polarization beam splitter module 21 is changeable or adjustable by adjusting the first focus adjusting element 25. In addition, the second image generating unit 3 includes a second focus adjusting element 35 disposed on the top side 110 of the main casing 11, and a second distance D2 between the centric position of the second lens module 34 and the centric position of the second polarization beam splitter module 31 is changeable or adjustable by adjusting the second focus adjusting element 35. Moreover, referring to FIG. 2 and FIG. 3, the first image generating unit 2 includes a first position adjusting element 26 disposed on the bottom side 111 of the main casing 11, the second image generating unit 3 includes a second position adjusting element 36 disposed on the bottom side 111 of the main casing 11, and a third distance D3 between a first optical axis X1 of the first lens module 24 and a second optical axis X2 of the second lens module 34 is changeable or adjustable by adjusting the first focus adjusting element 26 and the second focus adjusting element 36.

Furthermore, referring to FIG. 1 and FIG. 2, the two earphone structures 4 are respectively disposed on the two inner side surfaces 112 of the two lateral casings 12. For example, one of the two earphone structures 4 has at least one electrical connector socket 41, at least one electrical connection jack 42, a volume adjusting button 43, and a power switch 44. Please note, the wearable audio-visual device Z can be rotated by 90 degrees as shown in FIG. 6.

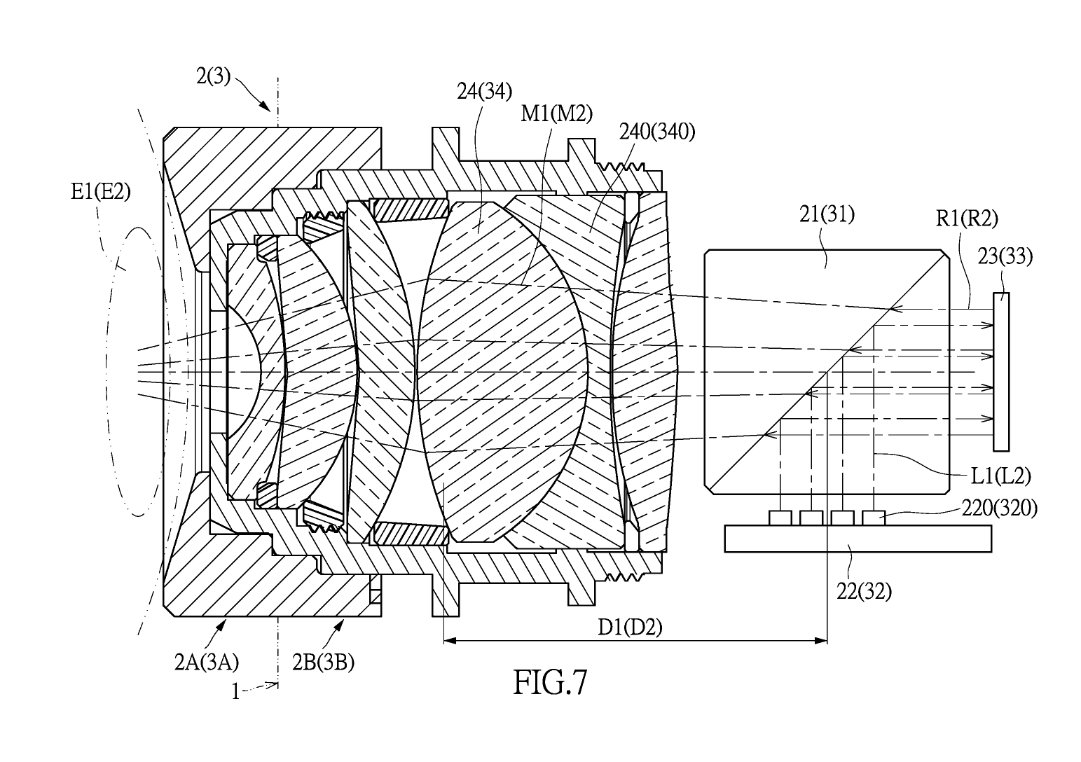

More particularly, as shown in FIG. 7, the instant disclosure further provides another first image generating unit 2 and another second image generating unit 3. A first light source L1 generated by the first light emitting module 22 is reflected by the first polarization beam splitter module 21 and then is projected onto the first image display module 23, the first light source L1 is reflected by the first image display module 23 to form a first image light source R1, and the first image light source R1 sequentially passes through the first polarization beam splitter module 21 and the first lens module 24 to form a first eye image light source M1 that is projected onto the first eye E1 of the user. In addition, a second light source L2 generated by the second light emitting module 32 is reflected by the second polarization beam splitter module 31 and then is projected onto the second image display module 33, the second light source L2 is reflected by the second image display module 33 to form a second image light source R2, and the second image light source R2 sequentially passes through the second polarization beam splitter module 31 and the second lens module 34 to form a second eye image light source M2 that is projected onto the second eye E2 of the user.

The aforementioned descriptions merely represent the preferred embodiments of the instant disclosure, without any intention to limit the scope of the instant disclosure which is fully described only within the following claims. Various equivalent changes, alterations or modifications based on the claims of the instant disclosure are all, consequently, viewed as being embraced by the scope of the instant disclosure.

What is claimed is:

1. A wearable audio-visual device worn on the head of a user, comprising:
a casing structure including a main casing and two lateral casings respectively connected to two opposite sides of the main casing, wherein the main casing has a top side, a bottom side, and an inner side surface, each lateral casing has an inner side surface, and the two inner side surfaces of the two lateral casings correspond to each other;
a first image generating unit including a first polarization beam splitter module, a first light emitting module adjacent to the first polarization beam splitter module, a first image display module adjacent to the first polarization beam splitter module, and a first lens module adjacent to the first polarization beam splitter module, wherein one portion of the first lens module is exposed from the inner side surface of the main casing and corresponds to a first eye of the user, and the first polarization beam splitter module, the first light emitting module, the first image display module, and the other portion of the first lens module are enclosed inside the main casing;
a second image generating unit including a second polarization beam splitter module, a second light emitting module adjacent to the second polarization beam splitter module, a second image display module adjacent to the second polarization beam splitter module, and a second lens module adjacent to the second polarization beam splitter module, wherein one portion of the second lens module is exposed from the inner side surface of the main casing and corresponds to a second eye of the user, and the second polarization beam splitter module, the second light emitting module, the second image display module, and the other portion of the second lens module are enclosed inside the main casing; and
two earphone structures respectively disposed on the two inner side surfaces of the two lateral casings;
wherein a first light source generated by the first light emitting module passes through the first polarization beam splitter module and then is projected onto the first image display module, the first light source is reflected by the first image display module to form a first image light source, and the first image light source is reflected by the first polarization beam splitter module and then passes through the first lens module to form a first eye image light source that is projected onto the first eye of the user;
wherein a second light source generated by the second light emitting module passes through the second polarization beam splitter module and then is projected onto the second image display module, the second light source is reflected by the second image display module to form a second image light source, and the second image light source is reflected by the second polarization beam splitter module and then passes through the second lens module to form a second eye image light source that is projected onto the second eye of the user.

2. The wearable audio-visual device of claim 1, wherein the first lens module has a first viewing area exposed from the inner side surface of the main casing, and the second lens module has a second viewing area exposed from the inner side surface of the main casing, wherein the casing structure includes a movable cover plate movably disposed on the inner side surface of the main casing, and two opposite end portions of the movable cover plate are respectively pivotally disposed on two opposite positions of the inner side surface of the main casing so as to concurrently cover or expose the first viewing area of the first lens module and the second viewing area of the second lens module.

3. The wearable audio-visual device of claim 1, wherein the first image generating unit includes a first focus adjusting element disposed on the top side of the main casing, and a first distance between the first lens module and the first polarization beam splitter module is changeable by adjusting the first focus adjusting element, wherein the second image generating unit includes a second focus adjusting element disposed on the top side of the main casing, and a second distance between the second lens module and the second polarization beam splitter module is changeable by adjusting the second focus adjusting element, wherein the first image generating unit includes a first position adjusting element disposed on the bottom side of the main casing, the second image generating unit includes a second position adjusting element disposed on the bottom side of the main casing, and a third distance between a first optical axis of the first lens module and a second optical axis of the second lens module is changeable by adjusting the first focus adjusting element and the second focus adjusting element.

4. The wearable audio-visual device of claim 1, wherein the casing structure includes a movable nose pad movably disposed on the inner side surface of the main casing and a height adjusting element disposed on the top side of the main casing, and the movable nose pad is moved to abut against the nose of the user by adjusting the height adjusting element, wherein one of the two earphone structures has at least one electrical connector socket, at least one electrical connection jack, a volume adjusting button, and a power switch, wherein the first lens module is composed of a plurality of first lenses, and the second lens module is composed of a plurality of second lenses.

5. A wearable audio-visual device worn on the head of a user, comprising:
a casing structure including a main casing and two lateral casings respectively connected to two opposite sides of the main casing, wherein the main casing has a top side, a bottom side, and an inner side surface, each lateral casing has an inner side surface, and the two inner side surfaces of the two lateral casings correspond to each other;
a first image generating unit including a first polarization beam splitter module, a first light emitting module adjacent to the first polarization beam splitter module, a first image display module adjacent to the first polarization beam splitter module, and a first lens module adjacent to the first polarization beam splitter module, wherein one portion of the first lens module is exposed from the inner side surface of the main casing and corresponds to a first eye of the user, and the first polarization beam splitter module, the first light emitting module, the first image display module, and the other portion of the first lens module are enclosed inside the main casing;
a second image generating unit including a second polarization beam splitter module, a second light emitting module adjacent to the second polarization beam splitter module, a second image display module adjacent to the second polarization beam splitter module, and a second lens module adjacent to the second polarization beam splitter module, wherein one portion of the second lens module is exposed from the inner side surface of the main casing and corresponds to a second eye of the user, and the second polarization beam splitter module, the second light emitting module, the second image display module, and the other portion of the second lens module are enclosed inside the main casing; and
two earphone structures respectively disposed on the two inner side surfaces of the two lateral casings;
wherein a first light source generated by the first light emitting module is reflected by the first polarization beam splitter module and then is projected onto the first image display module, the first light source is reflected by the first image display module to form a first image light source, and the first image light source sequentially passes through the first polarization beam splitter module and the first lens module to form a first eye image light source that is projected onto the first eye of the user;
wherein a second light source generated by the second light emitting module is reflected by the second polarization beam splitter module and then is projected onto the second image display module, the second light source is reflected by the second image display module to form a second image light source, and the second image light source sequentially passes through the second polarization beam splitter module and the second lens module to form a second eye image light source that is projected onto the second eye of the user.

6. The wearable audio-visual device of claim 5, wherein the first lens module has a first viewing area exposed from the inner side surface of the main casing, and the second lens module has a second viewing area exposed from the inner side surface of the main casing, wherein the casing structure includes a movable cover plate movably disposed on the inner side surface of the main casing, and two opposite end portions of the movable cover plate are respectively pivotally disposed on two opposite positions of the inner side surface of the main casing so as to concurrently cover or expose the first viewing area of the first lens module and the second viewing area of the second lens module.

7. The wearable audio-visual device of claim 5, wherein the first image generating unit includes a first focus adjusting element disposed on the top side of the main casing, and a first distance between the first lens module and the first polarization beam splitter module is changeable by adjusting the first focus adjusting element, wherein the second image generating unit includes a second focus adjusting element disposed on the top side of the main casing, and a second distance between the second lens module and the second polarization beam splitter module is changeable by adjusting the second focus adjusting element, wherein the first image generating unit includes a first position adjusting element disposed on the bottom side of the main casing, the second image generating unit includes a second position adjusting element disposed on the bottom side of the main casing, and a third distance between a first optical axis of the first lens module and a second optical axis of the second lens module is changeable by adjusting the first focus adjusting element and the second focus adjusting element.

8. The wearable audio-visual device of claim 5, wherein the casing structure includes a movable nose pad movably disposed on the inner side surface of the main casing and a height adjusting element disposed on the top side of the main casing, and the movable nose pad is moved to abut against the nose of the user by adjusting the height adjusting element, wherein one of the two earphone structures has at least one electrical connector socket, at least one electrical connection jack, a volume adjusting button, and a power switch, wherein the first lens module is composed of a plurality of first lenses, and the second lens module is composed of a plurality of second lenses.

9. A wearable audio-visual device worn on the head of a user, comprising:
a casing structure including a main casing and two lateral casings respectively connected to two opposite sides of the main casing;
a first image generating unit including a first exposed portion exposed from the main casing and a first hidden portion enclosed inside the main casing, wherein the first exposed portion has a first viewing area corresponding to a first eye of the user, and a first eye image light source generated by the first image generating unit passes through the first viewing area and then is projected onto the first eye of the user;
a second image generating unit including a second exposed portion exposed from the main casing and a second hidden portion enclosed inside the main casing, wherein the second exposed portion has a second viewing area corresponding to a second eye of the user, and a second eye image light source generated by the second image generating unit passes through the second viewing area and then is projected onto the second eye of the user; and
two earphone structures respectively disposed on the two lateral casings.

10. The wearable audio-visual device of claim 9, wherein the casing structure includes a movable cover plate movably disposed on the main casing, and two opposite end portions of the movable cover plate are respectively pivotally disposed on two opposite positions of the main casing so as to concurrently cover or expose the first viewing area of the first lens module and the second viewing area of the second lens module, wherein the casing structure includes a movable nose pad movably disposed on the main casing and a height adjusting element disposed on the top side of the main casing, and the movable nose pad is moved to abut against the nose of the user by adjusting the height adjusting element, wherein one of the two earphone structures has at least one electrical connector socket, at least one electrical connection jack, a volume adjusting button, and a power switch.
